(19) United States
(12) Patent Application Publication
(10) Pub. No.: US 2025/0258719 A1
(43) Pub. Date: Aug. 14, 2025

(54) Memory Bandwidth Monitor and Limiter

(71) Applicant: QUALCOMM Incorporated, San Diego, CA (US)

(72) Inventors: Sudheer PAPOTHI, San Diego, CA (US); Sri Venkatesh GODAVARI, San Diego, CA (US); Sriranga RANGANATH, Bangalore (IN)

(21) Appl. No.: 18/440,523

(22) Filed: Feb. 13, 2024

(51) Int. Cl. G06F 9/50

(52) U.S. Cl. CPC G06F 9/5077; G06F 9/5016

(57) ABSTRACT

A multiprocessing apparatus includes memory configured to support a maximum data access rate expressed as memory bandwidth, a plurality of subsystems coupled to the memory, each of the plurality of subsystems being configured to switch between two or more contexts, a bandwidth monitoring subsystem configured to limit access to the memory by a first subsystem to a first portion of the memory bandwidth when the first subsystem is configured for a first context, and to limit access to the memory by the first subsystem to a second portion of the memory bandwidth when the first subsystem is configured for a second context, and a resource management subsystem configured to enforce memory bandwidth limitations defined by the bandwidth monitoring subsystem based on context in which the first subsystem is operated.

### TECHNICAL FIELD

The present disclosure relates generally to integrated circuit technology and, more particularly to managing access to memory in a multiprocessing system.

### BACKGROUND

Vehicles, including automobiles, trucks, watercraft and other types of vehicle are increasingly fitted with complex electronic systems that are used for system management, control, and security. For example, it is common for vehicles to include a navigation system that, in many instances, can be used to support autonomous operation of the vehicle. In the latter example, a control system may communicate with the navigation system, a steering system and a powertrain or other propulsion system in addition to a variety of sensors that provide feedback used to control operation of the vehicle. The various systems in a vehicle may be implemented using a variety of components such as circuit boards, integrated circuit (IC) devices, application-specific integrated circuit (ASIC) devices and/or System-on-Chip (SoC) devices. The types of components may include processing circuits, user interface components, storage and other peripheral components. A communication infrastructure may be provided to support data communication within and between various systems or subsystems. The communication infrastructure may include some combination of wireless and wired communication links. Automobiles are increasingly subject to, or dependent upon safety standards and risk classification schemes in order to manage the significant risk that automobiles traveling at speed pose to passenger and pedestrian lives. Certain safety standards are defined by the International Organization for Standardization (ISO) standard for “Functional Safety For Road Vehicles,” which may be referred to herein as “ISO 26262.” ISO 26262 defines functional safety as “the absence of unreasonable risk due to hazards caused by malfunctioning behavior of electrical or electronic systems.” ISO 26262 defines an Automotive Safety Integrity Level (ASIL) risk classification scheme that stipulate or recommend various safety requirements. A vehicle function or system may be classified in one of four progressively more stringent ASIL levels: ASIL-A, ASIL-B, ASIL-C, and ASIL-D. ASIL-A includes the lowest or least stringent integrity requirements, and ASIL-D includes the highest or most stringent integrity requirements.

Certain ASIL levels relate to processing and communication of information within an automobile, including the use or operation of communication systems that define or control wired or wireless communication systems deployed or supported within a vehicle. Examples of wireless communication systems include systems managed using certain standards defined by the Institute of Electrical and Electronics Engineers (IEEE) 802.11 Working Group, the Bluetooth® standards defined by the Bluetooth Special Interest Group (SIG) and radio access standards defined by the 3rd Generation Partnership Project (3GPP). Examples of wired communication systems include systems managed using Peripheral Component Interconnect Express (PCIe), Advanced eXtensible Interface (AXI), HyperTransport and InfiniBand standards or protocols. Other examples of wired communication systems include systems managed using standards defined by the Mobile Industry Processor Interface (MIPI) Alliance and the CAN bus Standard promulgated by the International Organization for Standardization (ISO).

As device technology improves, there is an ongoing need to improve the resilience, reliability and availability of automotive systems.

### SUMMARY

Certain aspects of the disclosure relate to IC devices that include multiple subsystems that contend for access to memory. In one aspect memory access may be managed to eliminate or reduce memory bottlenecks and contention for memory bandwidth and thereby improve the resilience, reliability and availability of multiprocessing systems that access a common memory.

In various aspects of the disclosure, a multiprocessing apparatus includes memory configured to support a maximum data access rate expressed as memory bandwidth, a plurality of subsystems coupled to the memory, each of the plurality of subsystems being configured to switch between two or more contexts, a bandwidth monitoring subsystem configured to limit access to the memory by a first subsystem to a first portion of the memory bandwidth when the first subsystem is configured for a first context, and to limit access to the memory by the first subsystem to a second portion of the memory bandwidth when the first subsystem is configured for a second context, and a resource management subsystem configured to enforce memory bandwidth limitations defined by the bandwidth monitoring subsystem based on context in which the first subsystem is operated.

In various aspects of the disclosure, a method for managing memory access includes allocating memory bandwidth among two or more subsystems based on current contexts of the two or more subsystems, the memory bandwidth corresponding to a maximum data access rate associated with a memory, limiting access to the memory by a first subsystem to a first portion of the memory bandwidth when the first subsystem is configured for a first context, limiting access to the memory by the first subsystem to a second portion of the memory bandwidth when the first subsystem is configured for a second context, and enforcing memory bandwidth limitations defined for the first subsystem based on context in which the first subsystem is operated.

In various aspects of the disclosure, an apparatus includes means for enforcing memory bandwidth limitations on a plurality of subsystems, each of the plurality of subsystems being operable in two or more contexts, each context being associated with a memory bandwidth allocation, and means for providing virtualized contexts in which one or more of the plurality of subsystems are operated.

In certain aspects, the first context corresponds to a first use case and the second context corresponds to a second use case. The first use case may be associated with a safety requirement. The first portion of the memory bandwidth may be unlimited when the first use case is associated with a safety requirement.

In certain aspects, a hypervisor is configured to provide virtualized contexts in which virtual machines are operated. The first context may be a first virtualized context and the second context may be a second virtualized context. The bandwidth monitoring subsystem may include a first bandwidth monitor configured to limit access to the memory by the first subsystem when the first subsystem is configured for the first context, and a second bandwidth monitor configured to limit access to the memory by the first subsystem when the first subsystem is configured for the second context. The first virtualized context may be associated with a safety requirement. The first portion of the memory bandwidth may be unlimited when the first virtualized context is associated with a safety requirement.

In certain aspects, the memory bandwidth limitations correspond to an allocation of the memory bandwidth among the plurality of subsystems. The bandwidth monitoring subsystem may be configured to redefine the memory bandwidth limitations when changes are detected in memory bandwidth usage. The changes that are detected in memory bandwidth usage may be indicated by measurements of the data access rate associated with the memory.

### BRIEF DESCRIPTION OF THE DRAWINGS

FIG. 1 illustrates an example of systems in an automobile that may be adapted, configured or operated in accordance with certain aspects of this disclosure.

FIG. 2 illustrates certain aspects of an SoC constructed from chiplets.

FIG. 3 illustrates an example of an SoC in which chiplets are stacked vertically on a substrate.

FIG. 4 illustrates an example of a system that may be adapted to operate in accordance with certain aspects of this disclosure.

FIG. 5 illustrates an example of a system that is configured to provide a virtual environment.

FIG. 6 illustrates an example of a system that can be configured to reliably manage memory subsystem bandwidth in accordance with certain aspects of this disclosure.

FIG. 7 illustrates an example of a system that supports a virtual environment and that can be configured to reliably manage memory subsystem bandwidth in accordance with certain aspects of this disclosure.

FIG. 8 illustrates one example of an apparatus employing a processing circuit that may be adapted according to certain aspects disclosed herein.

FIG. 9 is a flowchart of a method for managing memory access in accordance with certain aspects of this disclosure.

FIG. 10 illustrates an example of a hardware implementation for a communication apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Certain aspects of this disclosure are applicable to an apparatus that is implemented using multiple integrated circuit devices, including System-on-Chip (SoC) devices or packages and other integrated circuit (IC) devices. In some implementations, an SoC may be constructed from multiple interconnected chiplets. Data communication links may be deployed between or within SoCs and/or between SoCs and other IC devices. In one example, one or more data communication links may be deployed between or within chiplets provided on a chip carrier within an IC package. For example, data communication links may be implemented to connect processors with modems and other peripherals. The data communication links may be operated in accordance with industry or proprietary standards or protocols associated with certain functions or types of devices. In one example, the peripheral component interconnect express (PCIe) standard is a high-speed interface that enables transmission over a high-speed link at data rates measured in gigabits per second. A high-speed interface operated in accordance with PCIe standards and protocols has multiple standby modes when the link is inactive. In operation, one device acts as a host that can communicate through PCIe links with multiple devices, which may be referred to as endpoints. In a PCIe link, data is transmitted in differential signals over one or more two-line lanes. Lanes may provide duplex, serial point-to-point connections.

Certain aspects of the disclosure are applicable to data communication interfaces that include serializer/deserializer (SERDES) circuits. For example, SERDES-based data communication interfaces may be used in communication links operated in accordance with PCIe protocols, and/or in accordance with Advanced High-Performance Bus (AHB) protocols defined by Advanced Microcontroller Bus Architecture (AMBA) specifications. SERDES-based data communication interface may be used to provide an interface between core circuits and Synchronous Dynamic Random Access Memory (SDRAM) devices, including Low-Power double data rate SDRAM (LPDDR SDRAM) that can be configured for high-speed and low-power modes of operation.

High-speed data communication interfaces may be used to interconnect certain electronic devices that are subcomponents of an apparatus such as a vehicle management system, a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, or any other similarly functioning device.

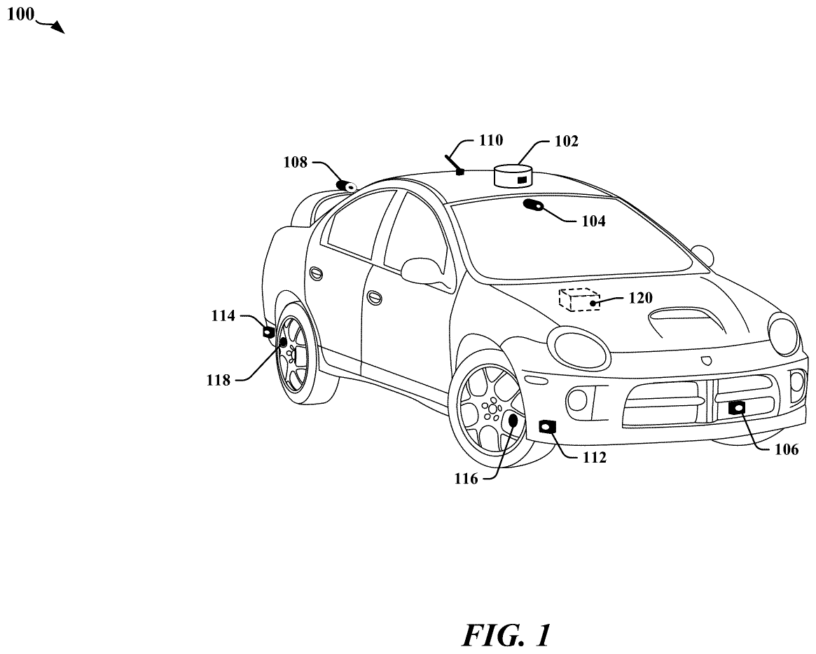

FIG. 1 illustrates an example of an automobile 100 that includes systems that may be adapted, configured or operated in accordance with certain aspects of this disclosure. The automobile 100 may be equipped with multiple imaging or sensing devices including, for example, the illustrated cameras or sensors 102, 104, 106, 108, 112, 114. The automobile 100 may include sensors such as tire pressure or braking sensors 116, 118. The automobile 100 may also include one or more antennas 110 used for radio frequency reception, wireless communication and/or radio navigation using a global positioning system (GPS). A central controller 120 may be coupled to each of the cameras 102, 104, 106, 108, 112, 114, sensors 116, 118 and antennas 110. The central controller 120 may configure and manage automated systems and/or driver assistance systems. In some implementations, the central controller 120 may be configured to operate as an engine control unit that manages the operation and performance of the engine, motor, motors or other power systems in the automobile 100. In some instances, the central controller 120 may be embodied in a SoC device or package.

Robust data communication links are needed to support the large number of cameras deployed within the automobile 100. In some examples, 20-30 cameras may be deployed to support automation and driver assistance systems. Each camera may be capable of generating data at a rate of between 1-10 gigabits per second (Gbps) resulting in aggregate data rates of up to 300 Gbps. The communication of this volume of data can be expected to result in the consumption of high levels of power and the generation of associated heat from interface and data protection and processing circuits. In conventional systems, data rates may be reduced to control power consumption and heat generation, resulting in loss of image quality.

ICs are typically packaged in an IC package, which may be referred to as a “semiconductor package” or “chip package.” The IC package typically includes a package substrate and one or more IC chips or other electronic modules mounted to the package substrate to provide electrical connectivity to the IC chips. For example, an IC chip in an IC package may be configured as an SoC. The IC chips are electrically coupled to other IC chips and/or to other components in the IC package through electrical coupling to metal lines in the package substrate. The IC chips can also be electrically coupled to other circuits outside the IC package through electrical connections of external metal interconnects (e.g., solder bumps) of the IC package.

Process technology employed to manufacture semiconductor devices, including IC devices is continually improving. Process technology includes the manufacturing methods used to make IC devices and defines transistor size, operating voltages and switching speeds. Features that are constituent elements of circuits in an IC device may be referred as technology nodes and/or process nodes. The terms technology node, process node, process technology may be used to characterize a specific semiconductor manufacturing process and corresponding design rules. Faster and more power-efficient technology nodes are being continuously developed through the use of smaller feature size to produce smaller transistors that enable the manufacture of higher-density ICs. Design rules for newer process technology that use low-voltage transistors may preclude the use of higher voltage transistors supported by previous process technology generations. The unavailability of certain higher-voltage transistors may present an impediment to circuit designers for IC devices that include multiple voltage domains.

The increasing complexity and functionality required from semiconductor devices tends to increase the physical dimensions of integrated circuit devices in which they are embodied. An upper limit on integrated circuit device is the maximum “reticle” size that in some instances refers to the size of the photomask used to manufacture the integrated circuit devices. Chiplets provide one approach to avoiding the maximum reticle size. Moreover, chiplet technology can be used to address some of the performance, power and size design requirements for complex SoCs, including SoCs used in certain mobile or wearable devices. The use of smaller dies can improve manufacturing yields.

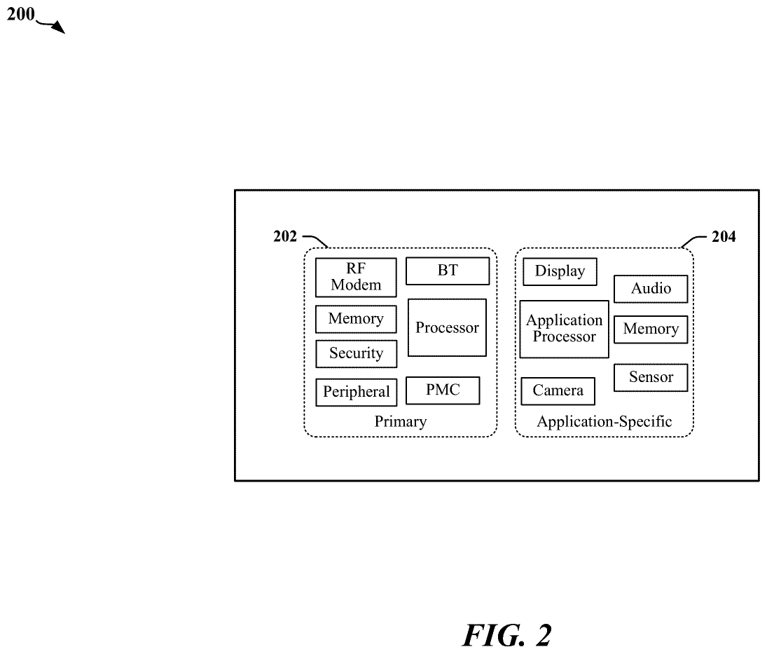

The block diagram in FIG. 2 illustrates certain aspects of an SoC 200 that can be constructed using chiplets. The SoC 200 may be configured by selecting a combination of chiplets that implement certain subsystems or distinct functional elements. In the illustrated example, the SoC 200 includes a set of primary chiplets 202 that enable the SoC 200 to perform core processing, security and communication functions. The set of primary chiplets 202 include a processor, memory and one or more modems. The illustrated SoC 200 also includes a set of application-specific chiplets 204 that includes an application processor, display driver, camera interface and audio controller. In a remote sensing device or appliance, the audio-visual components could be omitted and may be replaced with analog-to-digital controllers, for example.

The SoC 200 may include a variety of processing engines, such as central processing units (CPUs) with multiple cores, graphical processing units (GPUs), digital signal processors (DSPs), neural processing units (NPUs), wireless transceiver units (also referred to as modems), peripherals, display and imaging interfaces, etc. Each of these subsystems and other functional elements can be implemented as an individual chiplet, or as a combination of chiplets. The chiplets included in the SoC 200 can be proprietary or may be acquired from a variety of sources. An SoC may be constructed from chiplets manufactured at different process nodes and/or operated at different voltages.

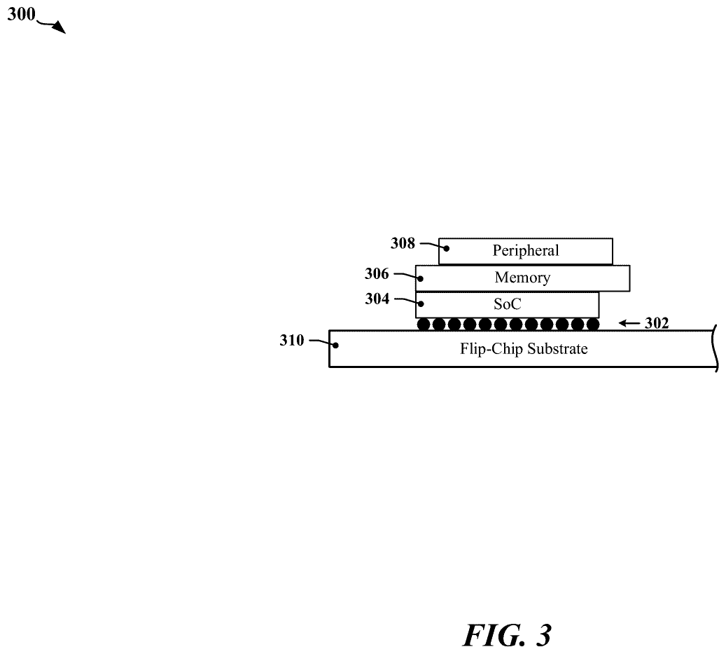

FIG. 3 illustrates an example of an SoC 300 in which certain chiplets 304, 306, 308 are stacked vertically on a substrate 310. Some chiplets can be included in stacks that are deployed across the surface of the substrate 310, while other chiplets may be individually mounted on the surface of the substrate. Chiplets may be mounted on the surface of the substrate using solder balls 302 that provide electrical and/or thermal coupling between substrate and the mounted chiplets. An interconnect structure may be formed that enables chiplets 304, 306, 308 in a stack of chiplets to communicate with one another, with other chiplets mounted on the substrate 310 and with input/output structures that connect the SoC 200 with other circuits, displays, imaging sensors and other peripherals with an apparatus.

The use of chiplets can reduce the areal size of the substrate 310 and increase three-dimensional packing density. The constituent chiplets may provide complex features and high performance within a smaller form-factor operated at lower power specifications. Moreover, each chiplet may define multiple power domains, operate at different frequencies and different chiplets may manage power/frequency modes independently and. In some instances, two or more chiplets may be operated in mutually exclusive power states. Additionally, operating conditions for an SoC depend on the type, number and arrangement of chiplets included on the substrate in addition to the modes of operation defined by applications. It is necessary to consider power usage by all chiplets in the SoC in order to ensure compliance with power budgets assigned for an application or device.

Each chiplet in an SoC may be included to perform a specific function or type of function and the configuration of the chiplets can introduce further complexities and challenges for designers. For example, one chiplet may include radio frequency front end circuits that produce high frequency signals ranging up to 5 GHz or more, and may further include interfaces that are used by low-frequency power management circuits. A designer may import previously defined circuit blocks to implement some of the internal functions. These circuit blocks may be referred to as macros. Imported circuit blocks for a given process technology may be described, characterized or defined by a set of masks, hardware description language, specifications and test data. Commercially available or proprietary circuit blocks may be referred to as hard macros. Hard macros are tested and verified for a set of design and operating specifications. It is common for hard macros and other circuit blocks to define multiple power domains.

The Universal Chiplet Interconnect Express (UCIe) is an example of a standardized chiplet interconnect specification. The UCIe specification enables construction of large SoC packages that in aggregate can exceed the maximum reticle size. The adoption of the UCIe specification has facilitated the integration of chiplets manufactured by different vendors into a single package. The UCIe specification enables the integration of chiplets fabricated using different silicon manufacturing processes into a single package, as required or desired for a specific device type, computing performance and/or to better meet power consumption budgets. The UCIe specification defines physical layer circuits and interconnects, protocol stacks and defines a software architecture and procedures to be used for compliance testing.

The UCIe specification defines different packaging options. One packaging option is the standard packaging option, which may also be referred to as the two-dimensional (2D) option. The standard packaging option may be applied to technology that can be used for low-cost devices and long-reach channels, where distances of between 10 mm and 25 mm may be considered to be long-reach. Another packaging option is the advanced packaging option, which may also be referred to as the 2.5D option. The advanced packaging option may be applied to technology that can be used for performance-optimized applications with short channel lengths. For example, channels that have a length that is less than 2 mm may be considered to be a short channel.

An SoC may employ one or more high-speed data communication buses for interconnecting devices and subcircuits with the SoC or within the SoC. The high-speed data communication buses operated in accordance with standardized or proprietary bus protocols. In one example, an SoC implemented using multiple chiplets mounted on a common chip carrier may be coupled through high-speed data communication buses operated according to UCIe protocols. In another example, an SoC may include one or more data communication buses that are operated in accordance with AHB protocols. In another example, an SoC may include one or more data communication buses that are operated in accordance with PCIe protocols. Other bus architectures or protocols may be employed to satisfy design or application requirements. Certain bus architectures may be deployed to support inter-processor communications, inter-device communications, sensor support, high-speed communication and/or memory interfaces.

Certain aspects of this disclosure are applicable to an apparatus that is implemented using a chip set that includes some combination of SoCs and peripheral devices. The chip set may include or be coupled to memory devices, which may include SDRAM devices. The SDRAM devices may conform to standards defined for LPDDR SDRAM. The apparatus may be configurable for a number of use cases and multiple applications may be concurrently executed by one or more processors provided by the chip set. A use case may refer to the operation of a system or subsystem in response to an input when the system or subsystem is operating in a given context. In one example, a display system in an automobile may provide an assortment of control information in a first use case in which the automobile is at rest or moving in a forward direction. The display system may provide a video feed when the automobile is moving in a forward direction. Use cases may provide or define context for operation of a subsystem or execution of an application. Each application and each use case may be allocated some portion of available SDRAM to support their respective operations. Access to the SDRAM may be provided through a combination of shared circuits and customized or proprietary logic circuits. A customized or proprietary logic circuit and its associated software modules may be referred to herein as an intellectual property (IP). It can be expected that a number of applications may access SDRAM concurrently through different IPs. The SDRAM may create or represent a bottleneck in conventional systems when peak demand for access from multiple applications and/or use cases exceeds SDRAM bandwidth. Such bottlenecks can produce performance related issues for safety critical applications.

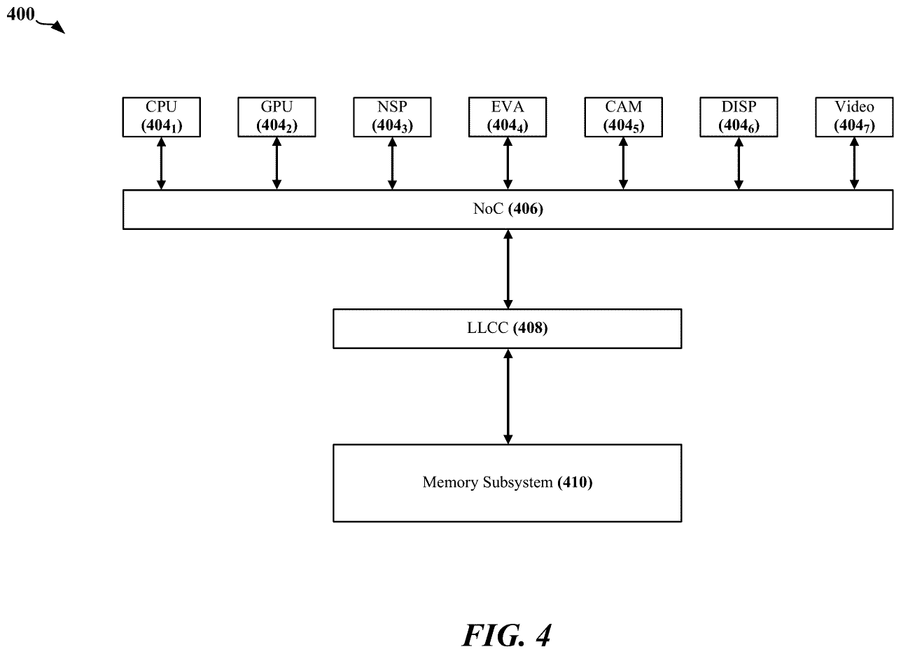

FIG. 4 illustrates an example of a system 400 that may be implemented using some combination of SoCs, chiplets and/or other IC devices. The illustrated system 400 includes multiple subsystems 404₁-404₇ that may be configured to manage, control or perform one or more functions. The subsystems 404₁-404₇ in FIG. 4 are merely illustrative examples. Other implementations may include different combinations of subsystems and/or other subsystems not shown in the example in FIG. 4. In some implementations, certain of the subsystems 404₁-404₇ include a processing circuit. In some implementations, certain of the subsystems 404₁-404₇ may be implemented using a shared processing circuit. In certain examples, a processing circuit includes a processor, a finite state machine (FSM) or another type of controller. The processing circuit may be configured using coded instructions or the like.

In the illustrated example, a central processing unit (the CPU 404₁) may include a processing circuit that can be used to support or configure the operation of other subsystems 404₂-404₇, in addition to performing certain predefined general-purpose operations. In the illustrated example, the graphic processing unit (the GPU 404₂) may be implemented using a include a dedicated processing circuit that supports one or more imaging and display subsystems 404₆, 404₇. In one example, a camera subsystem 404₅ may be configured to capture still images or a video feed from one or more imaging sensors. A display subsystem 404₆ may be configured to provide a user interface that can display images, video, control and status information and other types of viewable information such as maps and content provided by an entertainment subsystem, which may include a video subsystem 404₇ that can be used to retrieve, manage, format and/or generate video content. The illustrated system 400 includes a neural signal processing subsystem (the NSP subsystem 404₃) and an enhanced visual analytics subsystem (the EVA subsystem 404₄), each of which may include dedicated processing circuits equipped with specialized processors or controllers. The NSP subsystem 404₃ may be configured for machine learning. In some implementations, the GPU 404₂ may also be configured to support machine learning. The EVA subsystem 404₄ may be configured to process image data in order to extract operational information. In an automotive application, for example, the EVA subsystem 404₄ may be configured to detect pedestrians, road features, other vehicles and potential driving hazards.

In the illustrated system 400, each of the subsystems 404₁-404₇ is coupled to an internal high-speed data communication bus that is incorporated in a Network-on-Chip (the NoC 406). In some instances, the NoC 406 may be extended beyond a single chip and may couple an SoC to other IC devices and/or may include data communication links used to interconnect chiplets. The NoC 406 may include multiple segments, where two or more segments are operated at different speeds, support different numbers of communication channels and/or are operated in accordance with different bus protocols.

In the illustrated system 400, the subsystems 404₁-404₇ are coupled to a memory subsystem 410 through the NoC 406. The memory subsystem 410 may include memory devices such as SDRAM devices and the interface circuits required to access the memory devices. The memory devices may comprise dedicated IC devices, internal memory circuits or some combination of dedicated IC devices and internal memory circuits. In one example, high-speed internal memory circuits may be configured to provide cache subsystems that can be used to improve response times for memory read and write instructions. In the illustrated system 400, a last-level cache controller (the LLCC 408) may include high-speed internal memory circuits. The memory subsystem 410 may include or be coupled to external memory devices.

Access to the memory subsystem 410 may be limited to a maximum data access rate. The maximum data access rate may be referred to as the memory bandwidth. In one example, the memory bandwidth is expressed as a maximum number of combined data read and write commands or transactions that can be processed by the memory subsystem 410 within a defined period of time. In another example, the memory bandwidth is expressed as a maximum rate at which data bits can be read from or written to the memory subsystem 410. In another example, the memory bandwidth is expressed as a maximum rate at which data bytes can be read from or written to the memory subsystem 410. In another example, the memory bandwidth is expressed as a maximum rate at which data words of a predefined width can be read from or written to the memory subsystem 410. The memory bandwidth may be measured based on read and/or write transactions executed by one or more of the subsystems 404₁-404₇. In some instances, memory bandwidth may be measured when the LLCC 408 is disabled or operating in a passthrough mode.

Each of the subsystems 404₁-404₇ may be allocated some portion of available memory to support their respective operations. In some instances, a processing circuit in one or more of the subsystems 404₁-404₇ may be operated in a multitasking mode to perform mutually independent applications or functions that receive independent allocations of available memory. In conventional systems, the memory subsystem 410 may create or represent a bottleneck when multiple subsystems 404₁-404₇ concurrently demand or require access to the same memory devices. In these conventional systems, bandwidth control mechanisms based on managing dataflows by source and destination cannot account for sharing of subsystems 404₁-404₇ between multiple use cases. For example, it may be desirable to prioritize memory accesses by a display subsystem 404₆ when a vehicle is operated autonomously or when driver assist features are active during parking activities, whereas memory accesses by the display subsystem 404₆ can be substantially deprioritized when the display is used for entertainment purposes.

Demands for memory subsystem bandwidth may be increased further, and can be complicated when a memory subsystem is expected to support a virtual environment. In a virtual environment, a virtual machine (VM) can access and use an underlying hardware environment without knowledge or relationship to other VMs that access and use the underlying hardware environment. A hypervisor or another component of the underlying hardware environment may be used to monitor and/or manage the virtual environment machine. In one example, a hypervisor employs some combination of hardware, firmware and software to initialize, control and/or manage one or more VMs supported by a system. The hypervisor may maintain information that defines the context for each VM initiated in a system. When used herein in relation to a VM, the term “context” refers to the state of a system from the perspective of a corresponding VM. Context may include the state of the underlying hardware environment, the state of an operating system executed within the VM and mappings between driver software resident in the VM and physical devices. Context may further define the state of one or more subsystems from the perspective of the corresponding VM. Context may further define the state of applications, processes, threads, state machines.

In some instances, the hypervisor can selectively activate and deactivate VMs that share certain resources. The hypervisor may capture the context of the system when a VM is deactivated and restore the context when the VM is reactivated. In some instances, the hypervisor virtualizes shared resources by intercepting requests from a VM, causing the virtualized shared resources to respond to the requests generated by the VM and then providing responses to the VM upon receipt from the virtualized shared resources. In one example, the virtualized shared resources may be implemented by one or more of the subsystems 404₁-404₇ illustrated in FIG. 4 and the hypervisor may maintain context information used to configure any subsystems 404₁-404₇ that are the target of requests generated by the VM.

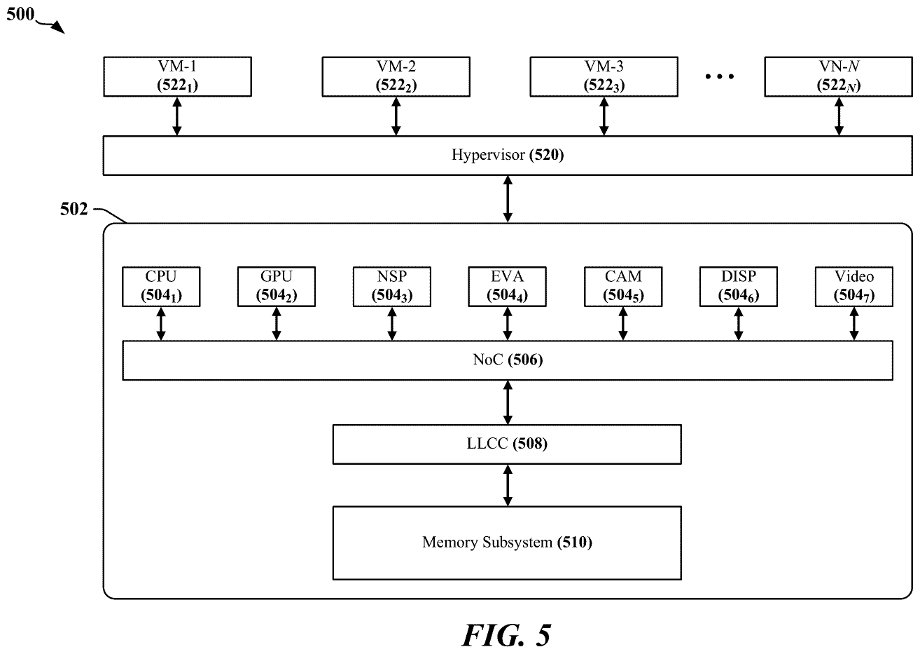

FIG. 5 illustrates an example of a system 500 that is configured to provide a virtual environment. A system core 502 may be implemented using some combination of SoCs, chiplets and/or other IC devices. The illustrated system core 502 includes multiple subsystems 504₁-504₇ that may be configured to manage, control or perform one or more functions. In some implementations, certain of the subsystems 504₁-504₇ include a processing circuit. In some implementations, certain of the subsystems 504₁-504₇ may be implemented using a shared processing circuit. In certain examples, a processing circuit includes a processor, an FSM or another type of controller. The processing circuit may be configured using coded instructions or the like.

In the illustrated example, a CPU 504₁ may include a processing circuit that can be used to support or configure the operation of other subsystems 504₂-504₇ in addition to performing certain predefined general-purpose operations. In the illustrated example, a GPU 504₂ may be implemented using a include a dedicated processing circuit that supports one or more imaging and display subsystems 504₆, 504₇. In one example, a camera subsystem 504₅ may be configured to capture still images or a video feed from one or more imaging sensors. A display subsystem 504₆ may be configured to provide a user interface that can display images, video, control and status information and other types of viewable information such as maps and content provided by an entertainment subsystem, which may include a video subsystem 504₇ that can be used to retrieve, manage, format and/or generate video content. The illustrated system core 502 includes an NSP subsystem 504₃ and an EVA subsystem 504₄, each of which may include dedicated processing circuits equipped with specialized processors or controllers. The NSP subsystem 504₃ may be configured for machine learning. In some implementations, the GPU 504₂ may also be configured to support machine learning. The EVA subsystem 504₄ may be configured to process image data in order to extract operational information. In an automotive application, for example, the EVA subsystem 504₄ may be configured to detect pedestrians, road features, other vehicles and potential driving hazards.

In the illustrated system core 502, each of the subsystems 504₁-504₇ is coupled to an internal high-speed data communication bus that is incorporated in a NoC 506. In some instances, the NoC 506 may be extended beyond a single chip and may couple an SoC to other IC devices and/or may include data communication links used to interconnect chiplets. The NoC 506 may include multiple segments, where two or more segments are operated at different speeds, support different numbers of communication channels and/or are operated in accordance with different bus protocols.

In the illustrated system core 502, the subsystems 504₁-504₇ are coupled to a memory subsystem 510 through the NoC 506. The memory subsystem 510 may include memory devices such as SDRAM devices and the interface circuits required to access the memory devices. The memory devices may comprise dedicated IC devices, internal memory circuits or some combination of dedicated IC devices and internal memory circuits. In one example, high-speed internal memory circuits may be configured to provide cache subsystems that can be used to improve response times for memory read and write instructions. In the illustrated system core 502, a LLCC 508 may include high-speed internal memory circuits. The memory subsystem 510 may include or be coupled to external memory devices.

Access to the memory subsystem 510 may be limited to a maximum data access rate. The maximum data access rate may be referred to as the memory bandwidth. In one example, the memory bandwidth is expressed as a maximum number of combined data read and write commands or transactions that can be processed by the memory subsystem 510 within a defined period of time. In another example, the memory bandwidth is expressed as a maximum rate at which data bits can be read from or written to the memory subsystem 510. In another example, the memory bandwidth is expressed as a maximum rate at which data bytes can be read from or written to the memory subsystem 510. In another example, the memory bandwidth is expressed as a maximum rate at which data words of a predefined width can be read from or written to the memory subsystem 510. The memory bandwidth may be measured based on read and/or write transactions executed by one or more of the subsystems 504₁-504₇. In some instances, memory bandwidth may be measured when the LLCC 508 is disabled or operating in a passthrough mode.

A virtual environment may be provided using the system core 502. A hypervisor 520 may be used by an individual SoC, by a system or by a chipset to implement, provide, support, configure and/or maintain virtualized contexts in which corresponding VMs 522₁-522_{N} can be executed or operated. The hypervisor 520 may be implemented using some combination of hardware and software. In one example, the hypervisor 520 may include circuits that provide hardware assisted virtualization. In another example, a processor in one or more of the subsystems 504₁-504₇ may provide hardware assisted virtualization that can be used to support the operation of the hypervisor 520.

The mutual independence of the VMs 522₁-522_{N} can complicate memory subsystem 510 bandwidth management. In one example, information regarding changes in bandwidth demand attributable to individual VMs 522₁-522_{N} is typically unavailable in conventional systems. In another example, bandwidth demand associated with subsystems 504₁-504₇ that are shared by multiple VMs 522₁-522_{N} can vary greatly over short periods of time as context switches between the VMs 522₁-522_{N}.

Certain aspects of this disclosure provide circuits, systems and techniques that can control bandwidth allocation across multiple use cases. Certain aspects of this disclosure provide circuits, systems and techniques that can control bandwidth allocation across multiple VMs in a hypervisor-managed virtual environment. In one aspect, an independently operated bandwidth management can be used to allocate and enforce bandwidth among multiple VMs, processes, use cases and subsystems.

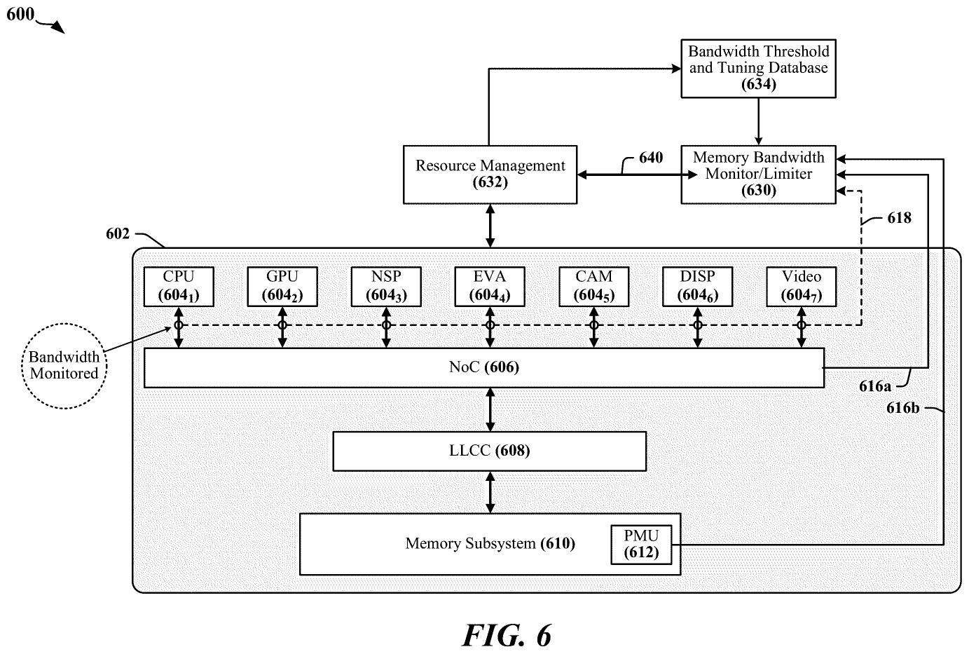

FIG. 6 illustrates an example of a system 600 that can be configured to reliably manage memory subsystem bandwidth in accordance with certain aspects of this disclosure. In this example, a virtualized environment is not provided or is disabled. A system core 602 may be implemented using some combination of SoCs, chiplets and/or other IC devices. The illustrated system core 602 includes multiple subsystems 604₁-604₇ that may be configured to manage, control or perform one or more functions. In some implementations, certain of the subsystems 604₁-604₇ include a processing circuit. In some implementations, certain of the subsystems 604₁-604₇ may be implemented using a shared processing circuit. In certain examples, a processing circuit includes a processor, an FSM or another type of controller. The processing circuit may be configured using coded instructions or the like.

In the illustrated example, a CPU 604₁ may include a processing circuit that can be used to support or configure the operation of other subsystems 604₂-604₇ in addition to performing certain predefined general-purpose operations. In the illustrated example, a GPU 604₂ may be implemented using a include a dedicated processing circuit that supports one or more imaging and display subsystems 604₅-604₇. In one example, a camera subsystem 604₅ may be configured to capture still images or a video feed from one or more imaging sensors. A display subsystem 604₆ may be configured to provide a user interface that can display images, video, control and status information and other types of viewable information such as maps and content provided by an entertainment subsystem, which may include a video subsystem 604₇ that can be used to retrieve, manage, format and/or generate video content. The illustrated system core 602 includes an NSP subsystem 604₃ and an EVA subsystem 604₄, each of which may include dedicated processing circuits equipped with specialized processors or controllers. The NSP subsystem 604₃ may be configured for machine learning. In some implementations, the GPU 604₂ may also be configured to support machine learning. The EVA subsystem 604₄ may be configured to process image data in order to extract operational information. In an automotive application, for example, the EVA subsystem 604₄ may be configured to detect pedestrians, road features, other vehicles and potential driving hazards.

In the illustrated system core 602, each of the subsystems 604₁-604₇ is coupled to an internal high-speed data communication bus that is incorporated in an NoC 606. In some instances, the NoC 606 may be extended beyond a single chip and may couple an SoC to other IC devices and/or may include data communication links used to interconnect chiplets. The NoC 606 may include multiple segments, where two or more segments are operated at different speeds, support different numbers of communication channels and/or are operated in accordance with different bus protocols.

In the illustrated system core 602, the subsystems 604₁-604₇ are coupled to a memory subsystem 610 through the NoC 606. The memory subsystem 610 may include memory devices such as SDRAM devices and the interface circuits required to access the memory devices. The memory devices may comprise dedicated IC devices, internal memory circuits or some combination of dedicated IC devices and internal memory circuits. In one example, high-speed internal memory circuits may be configured to provide cache subsystems that can be used to improve response times for memory read and write instructions. In the illustrated system core 602, a LLCC 608 may include high-speed internal memory circuits. The memory subsystem 610 may include or be coupled to external memory devices.

Access to the memory subsystem 610 may be limited to a maximum data access rate. The maximum data access rate may be referred to as the memory bandwidth. In one example, the memory bandwidth is expressed as a maximum number of combined data read and write commands or transactions that can be processed by the memory subsystem 610 within a defined period of time. In another example, the memory bandwidth is expressed as a maximum rate at which data bits can be read from or written to the memory subsystem 610. In another example, the memory bandwidth is expressed as a maximum rate at which data bytes can be read from or written to the memory subsystem 610. In another example, the memory bandwidth is expressed as a maximum rate at which data words of a predefined width can be read from or written to the memory subsystem 610. The memory bandwidth may be measured based on read and/or write transactions executed by one or more of the subsystems 604₁-604₇. In some instances, memory bandwidth may be measured when the LLCC 608 is disabled or operating in a passthrough mode.

Access to the memory subsystem 610 may be controlled using a memory bandwidth monitoring and/or limiting subsystem 630. The memory bandwidth monitoring and/or limiting subsystem 630 may include a combination of hardware and software circuits and modules. In one example, the memory bandwidth monitoring and/or limiting subsystem 630 may be implemented using a shared processing circuit. In another example, the memory bandwidth monitoring and/or limiting subsystem 630 may be implemented using a dedicated processing circuit. In certain examples, the memory bandwidth monitoring and/or limiting subsystem 630 may be implemented using a shared processing circuit that is controlled using a processor, an FSM or another type of controller.

The memory bandwidth monitoring and/or limiting subsystem 630 may communicate and/or cooperate with a resource management subsystem 632. The resource management subsystem 632 may be configured to track processes and use cases that are expected to access memory. The memory bandwidth monitoring and/or limiting subsystem 630 may communicate with the resource management subsystem 632 over a physical communication link 640 or using inter-process communication (IPC) facilities provided through local memory or registers that can be used to exchange messages between processors, controllers and/or applications. The resource management subsystem 632 may register and deregister processes and use cases when the processes and use cases are activated and deactivated, respectively. In one example, the resource management subsystem 632 may update a database subsystem 634 that associates processes and use cases with allocated or assigned bandwidth thresholds. The database subsystem 634 may be configured to tune the system core 602 based on current or expected levels of memory accesses. Information maintained by the database subsystem 634 may be used by the memory bandwidth monitoring and/or limiting subsystem 630 to enforce bandwidth thresholds in the system core 602.

In some implementations, the controllers in the subsystems 604₁-604₇ may be expected to self-manage memory bandwidth usage by reconfiguring applications and/or circuits that read or write shared system memory controlled by the memory subsystem 610. In some instances, the memory bandwidth monitoring and/or limiting subsystem 630 configures registers in the resource management subsystem 632 that define maximum memory bandwidth available to subsystems 604₁-604₇, processes and use cases. In one example, a display subsystem 604₆ may be configured to reduce resolution or refresh rate of the display based to meet memory bandwidth limitations. The display subsystem 604₆ may be configured to enforce memory bandwidth limits assigned for each application or use case that interacts with the display subsystem 604₆. Accordingly, higher memory bandwidths can be assigned for safety critical use cases or applications than for other use cases or application. In some instances, unlimited memory bandwidths may be assigned for use cases or applications that have safety requirements defined by safety standards.

In some implementations, the memory bandwidth monitoring and/or limiting subsystem 630 may enforce memory bandwidth thresholds by sending messages through the resource management subsystem 632 to cause controllers in the subsystems 604₁-604₇ to reconfigure applications and/or circuits that read or write shared system memory controlled by the memory subsystem 610. In some instances, the memory bandwidth monitoring and/or limiting subsystem 630 may send messages that cause the controllers in the subsystems 604₁-604₇ to selectively increase or decrease memory access rates based on measured memory bandwidth usage. Measurements of memory bandwidth usage may be obtained from messages 616a received from interface circuits in the NoC 606, or from messages 616b received from interface circuits or the memory subsystem 610. The dashed line 618 represents the logical flow of measurements to the bandwidth monitoring and/or limiting subsystem 630. In some implementations, bandwidth measuring circuits or modules may be installed in the system core 602, the LLCC 608, and/or the memory subsystem 610. In one example, a performance monitoring unit (the PMU 612) in the memory subsystem 610 may provide information that can be used to measure memory bandwidth usage. In some implementations, one or more PMUs 612 associated or collocated with an error correction circuit in the memory subsystem 610 can provide information on the memory bandwidth usage when the error correction circuit is enabled. In the latter example, it is expected that the error correction circuit is enabled for safety critical applications.

In some implementations, the memory bandwidth monitoring and/or limiting subsystem 630 may enforce memory bandwidth thresholds by controlling or limiting accesses to the memory subsystem 610 based to information or changes in information in the database subsystem 634. The memory bandwidth monitoring and/or limiting subsystem 630 may respond to detected changes in state of the system core 602 or when measurements of memory bandwidth usage indicate that memory bandwidth restrictions can be relaxed or should be tightened. Changes in state of the system core 602 may be associated with changes in use case or multitasking context. Safety critical contexts can be prioritized and assigned higher memory bandwidths.

Changes in context may occur in subsystems 604₁-604₇ that support multitasking or that support multiple use cases or applications. Safety critical contexts can be prioritized and assigned higher memory bandwidths. In some instances, unlimited memory bandwidths may be assigned in contexts that are associated with safety requirements defined by safety standards. Changes in context may also occur when the system core 602 supports a virtualized environment.

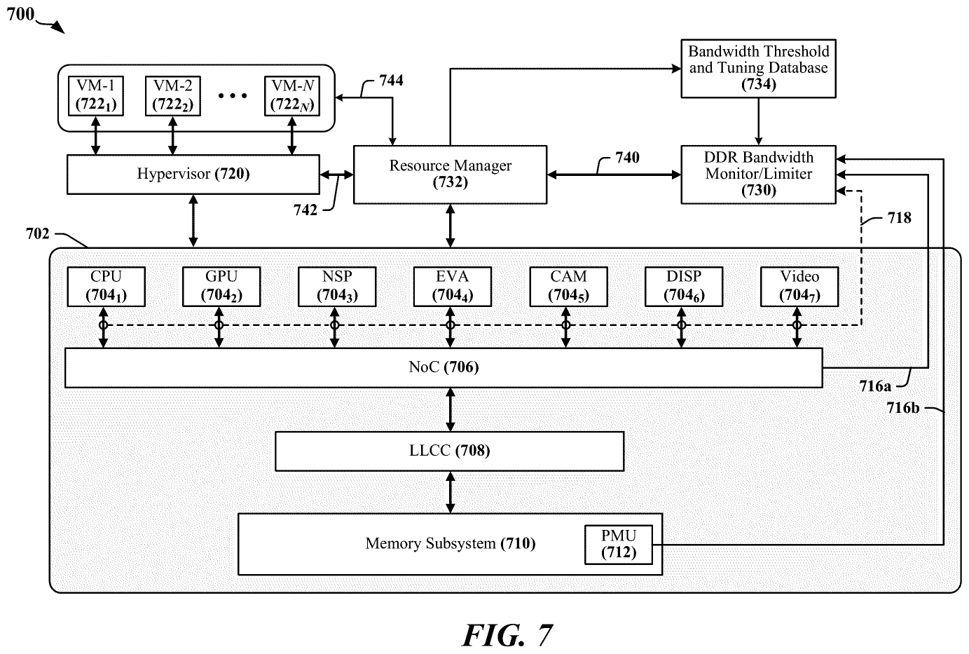

FIG. 7 illustrates an example of a system 700 that supports a virtual environment and that can be configured to reliably manage memory subsystem bandwidth in accordance with certain aspects of this disclosure. A system core 702 may be implemented using some combination of SoCs, chiplets and/or other IC devices. The illustrated system core 702 includes multiple subsystems 704₁-704₇ that may be configured to manage, control or perform one or more functions. In some implementations, certain of the subsystems 704₁-704₇ include a processing circuit. In some implementations, certain of the subsystems 704₁-704₇ may be implemented using a shared processing circuit. In certain examples, a processing circuit includes a processor, an FSM or another type of controller. The processing circuit may be configured using coded instructions or the like.

In the illustrated example, a CPU 704₁ may include a processing circuit that can be used to support or configure the operation of other subsystems 704₂-704₇ in addition to performing certain predefined general-purpose operations. In the illustrated example, a GPU 704₂ may be implemented using a include a dedicated processing circuit that supports one or more imaging and display subsystems 704₅-704₇. In one example, a camera subsystem 704₅ may be configured to capture still images or a video feed from one or more imaging sensors. A display subsystem 704₆ may be configured to provide a user interface that can display images, video, control and status information and other types of viewable information such as maps and content provided by an entertainment subsystem, which may include a video subsystem 704₇ that can be used to retrieve, manage, format and/or generate video content. The illustrated system core 702 includes an NSP subsystem 704₃ and an EVA subsystem 704₄, each of which may include dedicated processing circuits equipped with specialized processors or controllers. The NSP subsystem 704₃ may be configured for machine learning. In some implementations, the GPU 704₂ may also be configured to support machine learning. The EVA subsystem 704₄ may be configured to process image data in order to extract operational information. In an automotive application, for example, the EVA subsystem 704₄ may be configured to detect pedestrians, road features, other vehicles and potential driving hazards.

In the illustrated system core 702, each of the subsystems 704₁-704₇ is coupled to an internal high-speed data communication bus that is incorporated in an NoC 706. In some instances, the NoC 706 may be extended beyond a single chip and may couple an SoC to other IC devices and/or may include data communication links used to interconnect chiplets. The NoC 706 may include multiple segments, where two or more segments are operated at different speeds, support different numbers of communication channels and/or are operated in accordance with different bus protocols.

In the illustrated system core 702, the subsystems 704₁-704₇ are coupled to a memory subsystem 710 through the NoC 706. The memory subsystem 710 may include memory devices such as SDRAM devices and the interface circuits required to access the memory devices. The memory devices may comprise dedicated IC devices, internal memory circuits or some combination of dedicated IC devices and internal memory circuits. In one example, high-speed internal memory circuits may be configured to provide cache subsystems that can be used to improve response times for memory read and write instructions. In the illustrated system core 702, a LLCC 708 may include high-speed internal memory circuits. The memory subsystem 710 may include or be coupled to external memory devices.

Access to the memory subsystem 710 may be limited to a maximum data access rate. The maximum data access rate may be referred to as the memory bandwidth. In one example, the memory bandwidth is expressed as a maximum number of combined data read and write commands or transactions that can be processed by the memory subsystem 710 within a defined period of time. In another example, the memory bandwidth is expressed as a maximum rate at which data bits can be read from or written to the memory subsystem 710. In another example, the memory bandwidth is expressed as a maximum rate at which data bytes can be read from or written to the memory subsystem 710. In another example, the memory bandwidth is expressed as a maximum rate at which data words of a predefined width can be read from or written to the memory subsystem 710. The memory bandwidth may be measured based on read and/or write transactions executed by one or more of the subsystems 704₁-704₇. In some instances, memory bandwidth may be measured when the LLCC 708 is disabled or operating in a passthrough mode.

Access to the memory subsystem 710 may be controlled using a memory bandwidth monitoring and/or limiting subsystem 730. The memory bandwidth monitoring and/or limiting subsystem 730 may include a combination of hardware and software circuits and modules. In one example, the memory bandwidth monitoring and/or limiting subsystem 730 may be implemented using a shared processing circuit. In another example, the memory bandwidth monitoring and/or limiting subsystem 730 may be implemented using a dedicated processing circuit. In certain examples, the memory bandwidth monitoring and/or limiting subsystem 730 may be implemented using a shared processing circuit that is controlled using a processor, an FSM or another type of controller.

The memory bandwidth monitoring and/or limiting subsystem 730 may communicate and/or cooperate with a resource management subsystem 732. The resource management subsystem 732 may be configured to track processes and use cases that are expected to access memory. The memory bandwidth monitoring and/or limiting subsystem 730 may communicate with the resource management subsystem 732 over a physical communication link 740 or using inter-process communication (IPC) facilities provided through local memory or registers that can be used to exchange messages between processors, controllers and/or applications. The resource management subsystem 732 may register and deregister processes and use cases when the processes and use cases are activated and deactivated, respectively. In one example, the resource management subsystem 732 may update a database subsystem 734 that associates processes and use cases with allocated or assigned bandwidth thresholds. The database subsystem 734 may be configured to tune the system core 702 based on current or expected levels of memory accesses. Information maintained by the database subsystem 734 may be used by the memory bandwidth monitoring and/or limiting subsystem 730 to enforce bandwidth thresholds in the system core 702.

In some implementations, the controllers in the subsystems 704₁-704₇ may be expected to self-manage memory bandwidth usage by reconfiguring applications and/or circuits that read or write shared system memory controlled by the memory subsystem 710. In some instances, the memory bandwidth monitoring and/or limiting subsystem 730 configures registers in the resource management subsystem 732 that define maximum memory bandwidth available to subsystems 704₁-704₇, processes and use cases. In one example, a display subsystem 704₆ may be configured to reduce resolution or refresh rate of the display based to meet memory bandwidth limitations. The display subsystem 704₆ may be configured to enforce memory bandwidth limits assigned for each application or use case that interacts with the display subsystem 704₆. Accordingly, higher memory bandwidths can be assigned for safety critical use cases or applications than for other use cases or application. In some instances, unlimited memory bandwidths may be assigned for use cases or applications that have safety requirements defined by safety standards.

In some implementations, the memory bandwidth monitoring and/or limiting subsystem 730 may enforce memory bandwidth thresholds by sending messages through the resource management subsystem 732 to cause controllers in the subsystems 704₁-704₇ to reconfigure applications and/or circuits that read or write shared system memory controlled by the memory subsystem 710. In some instances, the memory bandwidth monitoring and/or limiting subsystem 730 may send messages that cause the controllers in the subsystems 704₁-704₇ to selectively increase or decrease memory access rates based on measured memory bandwidth usage. Measurements of memory bandwidth usage may be obtained from messages 716a received from interface circuits in the NoC 706, or from messages 716b received from interface circuits or the memory subsystem 710. The dashed line 718 represents the logical flow of measurements to the bandwidth monitoring and/or limiting subsystem 630. In some implementations, bandwidth measuring circuits or modules may be installed in the system core 702, the LLCC 708, and/or the memory subsystem 710. In one example, a performance monitoring unit (the PMU 712) in the memory subsystem 710 may provide information that can be used to measure memory bandwidth usage. In some implementations, one or more PMUs 712 associated or collocated with an error correction circuit in the memory subsystem 710 can provide information on the memory bandwidth usage when the error correction circuit is enabled. In the latter example, it is expected that the error correction circuit is enabled for safety critical applications.

In some implementations, the memory bandwidth monitoring and/or limiting subsystem 730 may enforce memory bandwidth thresholds by configuring a scheduling circuit or module that controls accesses to the memory subsystem 710. The memory bandwidth monitoring and/or limiting subsystem 730 may respond to information or changes in information in the database subsystem 734, when a change in state of the system core 702 is detected or when measurements of memory bandwidth usage indicate that memory bandwidth restrictions can be relaxed or should be tightened. Changes in state of the system core 702 may be associated with changes in use case or context. The memory bandwidth monitoring and/or limiting subsystem 730 may prioritize safety critical use cases or applications. Changes in context may occur in subsystems 704₁-704₇ that support multitasking or that support multiple use cases or applications. Safety critical contexts can be prioritized and assigned higher memory bandwidths. In some instances, unlimited memory bandwidths may be assigned in contexts that are associated with safety requirements defined by safety standards.

Changes in context that occur when the system core 702 supports a virtualized environment. In the illustrated example, the system core 702 supports or provides a virtual environment through the operation of a hypervisor 720, which may be configured to implement, provide, support, configure and/or maintain virtualized contexts in which corresponding VMs 722₁-722_{N} can be executed or operated. The hypervisor 720 may be implemented using some combination of hardware and software. In one example, the hypervisor 720 includes circuits that provide hardware assisted virtualization. In another example, a processor in one or more of the subsystems 704₁-704₇ may provide hardware assisted virtualization that can be used to support the operation of the hypervisor 720. According to certain aspects of this disclosure, the memory bandwidth monitoring and/or limiting subsystem 730 may communicate and/or cooperate with the hypervisor 720 and the resource management subsystem 732 to enforce memory bandwidth limitations. The hypervisor 720 may communicate with the resource management subsystem 732 over a physical communication link 742 or using IPC facilities provided through local memory or registers that can be used to exchange messages between processors, controllers and/or applications. In some implementations, the resource management subsystem 732 may additionally or alternatively communicate with one or more of the VMs 722₁-722_{N} over a physical communication link 744 or through the use of IPC facilities. The resource management subsystem 732 may register and deregister processes and use cases per VM 722₁-722_{N} after activation or deactivation of the VM 722₁-722_{N}. In one example, the resource management subsystem 732 may update a database subsystem 734 that associates processes and use cases within each of the VMs 722₁-722_{N} with allocated or assigned bandwidth thresholds. The database subsystem 734 may be configured to tune the system core 702 based on current or expected levels of memory accesses. Information maintained by the database subsystem 734 may be used by the memory bandwidth monitoring and/or limiting subsystem 730 to enforce bandwidth thresholds in the system core 702.

In some implementations, the controllers in the subsystems 704₁-704₇ may be expected to self-manage memory bandwidth usage by reconfiguring applications and/or circuits that read or write shared system memory controlled by the memory subsystem 710. In some instances, the memory bandwidth monitoring and/or limiting subsystem 730 configures registers in the resource management subsystem 732 that define maximum memory bandwidth available to subsystems 704₁-704₇, processes, applications and use cases within each of the VMs 722₁-722_{N}. In one example, a display subsystem 704₆ may be configured to reduce resolution or refresh rate of the display based to meet memory bandwidth limitations. The display subsystem 704₆ may be configured to enforce memory bandwidth limits assigned for each application or use case that interacts with the display subsystem 704₆. Accordingly, higher memory bandwidths can be assigned for safety critical use cases or applications than for other use cases or application. In some instances, unlimited memory bandwidths may be assigned for use cases or applications that have safety requirements defined by safety standards. In some implementations, safety critical use cases or applications may be restricted to one or more VMs 722₁-722_{N}, which may be provided high or unlimited memory bandwidths.

In some implementations, the memory bandwidth monitoring and/or limiting subsystem 730 may enforce memory bandwidth thresholds by sending messages through the resource management subsystem 732 to cause controllers in the subsystems 704₁-704₇ to reconfigure applications and/or circuits that read or write shared system memory controlled by the memory subsystem 710 based on application, use case and a currently active VM 722₁-722_{N}. In some instances, the memory bandwidth monitoring and/or limiting subsystem 730 may send messages that cause the controllers in the subsystems 704₁-704₇ to selectively increase or decrease memory access rates based on measured memory bandwidth usage. Measurements of memory bandwidth usage may be obtained from messages 716a received from interface circuits in the NoC 706, or from messages 716b received from interface circuits or error correction circuits registers in the memory subsystem 710. In some implementations, bandwidth measuring circuits or modules may be installed in the system core 702, the LLCC 708, and/or the memory subsystem 710.

In some implementations, the memory bandwidth monitoring and/or limiting subsystem 730 may enforce memory bandwidth thresholds by controlling or limiting accesses to the memory subsystem 710 based to information or changes in information in the database subsystem 734. The memory bandwidth monitoring and/or limiting subsystem 730 may respond to detected changes in state of the system core 702 or when measurements of memory bandwidth usage indicate that memory bandwidth restrictions can be relaxed or should be tightened. Changes in state of the system core 702 may be associated with changes in application, use case, and virtual context. The memory bandwidth monitoring and/or limiting subsystem 730 may prioritize accesses to the memory subsystem 710 for safety critical use cases, applications and/or VMs 722₁-722_{N}. Safety critical virtual contexts can be prioritized and assigned higher memory bandwidths. In some instances, unlimited memory bandwidths may be assigned in virtual contexts that are associated with safety requirements defined by safety standards.

A system 700 that is configured in accordance with certain aspects of this disclosure can maintain sufficient memory bandwidth to maintain adequate levels of performance and stability for critical applications. In some implementations, memory bandwidth usage can be monitored at each IP level in addition to monitoring aggregated memory bandwidth. Measurements may be captured in IP blocks provided in one or more subsystems 704₁-704₇. Measurements may be captured in IP blocks provided in interface circuits that couple subsystems 704₁-704₇ to the memory subsystem 710, including in an LLCC 708 and/or in interface circuits coupled to the NoC 706. The memory bandwidth monitoring and/or limiting subsystem 730 may determine bandwidth limits or changes in bandwidth limits based on performance or demand thresholds configured for application, use case, or virtual context. The memory bandwidth monitoring and/or limiting subsystem 730 may determine bandwidth limits or changes in bandwidth limits based on IP loading, criticality of an affected application and other factors that may impact system behavior. The memory bandwidth monitoring and/or limiting subsystem 730 may notify the resource management subsystem 732 of changes to configuration parameters associated with a use case that may result in reduced the memory bandwidth usage at the IP level.

According to certain aspects of this disclosure, memory bandwidth limits and/or thresholds may be configured using a runtime feedback mechanism that includes some combination of the memory bandwidth monitoring and/or limiting subsystem 730, the resource management subsystem 732 and the hypervisor 720. Feedback may include the measurements of memory bandwidth usage provided in the messages 716a, 716b, and/or changes in processes, applications, use cases and VM activity reported by the resource management subsystem 732, the hypervisor 720 and/or one or more of the VMs 722₁-722_{N}.

In some implementations, a version of the resource management subsystem 732 may be provided within each of the VMs 722₁-722_{N}. In some implementations, the resource management subsystem 732 may be distributed among the VMs 722₁-722_{N}. The resource management subsystem 732, or versions thereof, may configure individualized memory bandwidth limits or thresholds in each of the VMs 722₁-722_{N}. The resource management subsystem 732, or versions thereof, may reconfigure applications executed in each of the VMs 722₁-722_{N} when configured memory bandwidth limits or thresholds have been reached.

In some implementations, a use case, process or application may self-register with the resource management subsystem 732 and/or with the database subsystem 734 in order to receive the memory bandwidth notifications. Each use case, process or application may implement or activate a callback function that enables memory bandwidth to be controlled in a stepwise or by explicit configuration of a bandwidth level. In these implementations, the use case, process or application can take corrective action to tune memory bandwidth thresholds.

In some implementations, the control exercised over memory bandwidth taking into consideration virtual context, use case, process and/or application can eliminate or at least substantially reduce memory subsystem 710 contention. In these implementations, designers can configure memory bandwidth limits and thresholds for all expected operating conditions. In these implementations, designers can calculate expected memory bandwidth limits and headroom and can configure applications based on expected ability to access the memory subsystem 710.

Certain of the concepts disclosed herein are applicable to other shared or budgeted resources in a system. In one example, the resource management subsystem 732 can be coupled to a power supply monitor or limiter in order to manage power budgets in certain apparatus, including in battery powered devices. In another example, the resource management subsystem 732 can be coupled to thermal and/or power supply monitors or limiters in order to manage power dissipation and thermal issues in an apparatus.

### Examples of Processing Circuits and Methods

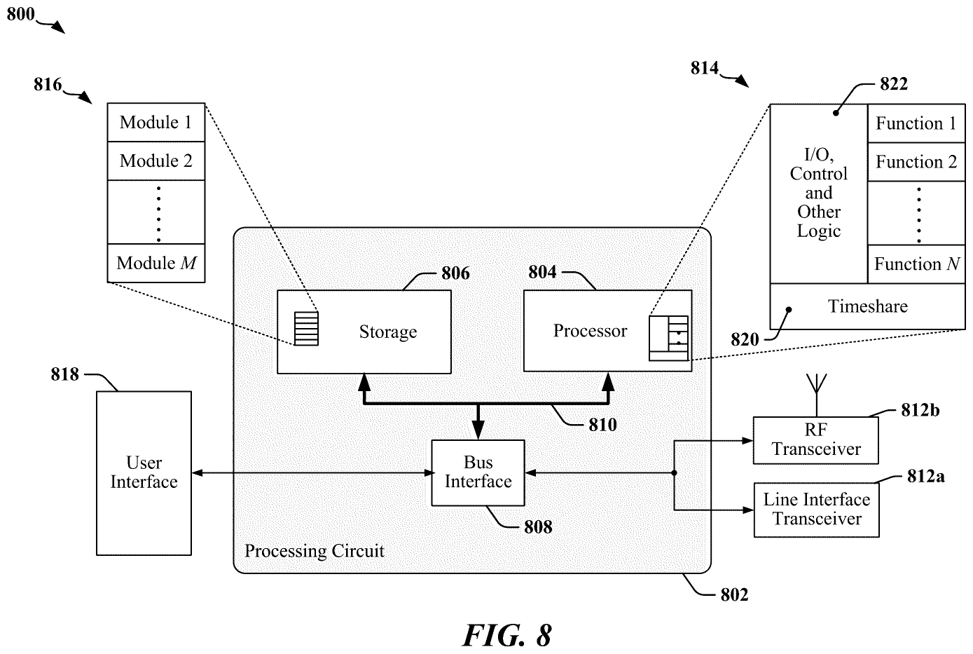

FIG. 8 is a diagram illustrating an example of a hardware implementation for an apparatus 800. In some examples, the apparatus 800 may perform one or more functions disclosed herein. In accordance with various aspects of the disclosure, an element, or any portion of an element, or any combination of elements as disclosed herein may be implemented using a processing circuit 802. The processing circuit 802 may include one or more processors 804 that are controlled by some combination of hardware and software modules. Examples of processors 804 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 804 may include specialized processors that perform specific functions, and that may be configured, augmented or controlled by one of the software modules 816. The one or more processors 804 may be configured through a combination of software modules 816 loaded during initialization, and further configured by loading or unloading one or more software modules 816 during operation.

In the illustrated example, the processing circuit 802 may be implemented with a bus architecture, represented generally by the bus 810. The bus 810 may include any number of interconnecting buses and bridges depending on the specific application of the processing circuit 802 and the overall design constraints. The bus 810 links together various circuits including the one or more processors 804, and storage 806. Storage 806 may include memory devices and mass storage devices, and may be referred to herein as computer-readable media and/or processor-readable media. The bus 810 may also link various other circuits such as timing sources, timers, peripherals, voltage regulators, and power management circuits. A bus interface 808 may provide an interface between the bus 810 and one or more transceivers 812a, 812b. A transceiver 812a, 812b may be provided for each networking technology supported by the processing circuit. In some instances, multiple networking technologies may share some or all of the circuitry or processing modules found in a transceiver 812a, 812b. Each transceiver 812a, 812b provides a means for communicating with various other apparatus over a transmission medium. In one example, a transceiver 812a may be used to couple the apparatus 800 to a multi-wire bus. In another example, a transceiver 812b may be used to connect the apparatus 800 to a radio access network. Depending upon the nature of the apparatus 800, a user interface 818 (e.g., keypad, display, speaker, microphone, joystick) may also be provided, and may be communicatively coupled to the bus 810 directly or through the bus interface 808.

A processor 804 may be responsible for managing the bus 810 and for general processing that may include the execution of software stored in a computer-readable medium that may include the storage 806. In this respect, the processing circuit 802, including the processor 804, may be used to implement any of the methods, functions and techniques disclosed herein. The storage 806 may be used for storing data that is manipulated by the processor 804 when executing software, and the software may be configured to implement certain methods disclosed herein.

One or more processors 804 in the processing circuit 802 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 806 or in an external computer-readable medium. The external computer-readable medium and/or storage 806 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 806 may also include, by way of example, a carrier wave, a transmission line, and any other suitable medium for transmitting software and/or instructions that may be accessed and read by a computer. Computer-readable medium and/or the storage 806 may reside in the processing circuit 802, in the processor 804, external to the processing circuit 802, or be distributed across multiple entities including the processing circuit 802. The computer-readable medium and/or storage 806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 806 may maintain software maintained and/or organized in loadable code segments, modules, applications, programs, etc., which may be referred to herein as software modules 816. Each of the software modules 816 may include instructions and data that, when installed or loaded on the processing circuit 802 and executed by the one or more processors 804, contribute to a run-time image 814 that controls the operation of the one or more processors 804. When executed, certain instructions may cause the processing circuit 802 to perform functions in accordance with certain methods, algorithms and processes described herein.

Some of the software modules 816 may be loaded during initialization of the processing circuit 802, and these software modules 816 may configure the processing circuit 802 to enable performance of the various functions disclosed herein. For example, some software modules 816 may configure internal devices and/or logic circuits 822 of the processor 804, and may manage access to external devices such as a transceiver 812a, 812b, the bus interface 808, the user interface 818, timers, mathematical coprocessors, and so on. The software modules 816 may include a control program and/or an operating system that interacts with interrupt handlers and device drivers, and that controls access to various resources provided by the processing circuit 802. The resources may include memory, processing time, access to a transceiver 812a, 812b, the user interface 818, and so on.

One or more processors 804 of the processing circuit 802 may be multifunctional, whereby some of the software modules 816 are loaded and configured to perform different functions or different instances of the same function. The one or more processors 804 may additionally be adapted to manage background tasks initiated in response to inputs from the user interface 818, the transceiver 812a, 812b, and device drivers, for example. To support the performance of multiple functions, the one or more processors 804 may be configured to provide a multitasking environment, whereby each of a plurality of functions is implemented as a set of tasks in a corresponding context that is serviced by the one or more processors 804 as needed or desired. In one example, the multitasking environment may be implemented using a timesharing program 820 that passes control of a processor 804 between different tasks, whereby each task returns control of the one or more processors 804 to the timesharing program 820 upon completion of any outstanding operations and/or in response to an input such as an interrupt. When a task has control of the one or more processors 804, the processing circuit operates in a corresponding context and is effectively specialized for the purposes addressed by the function associated with the controlling task. The timesharing program 820 may include an operating system, a main loop that transfers control on a round-robin basis, a function that allocates control of the one or more processors 804 in accordance with a prioritization of the functions, and/or an interrupt driven main loop that responds to external events by providing control of the one or more processors 804 to a handling function.

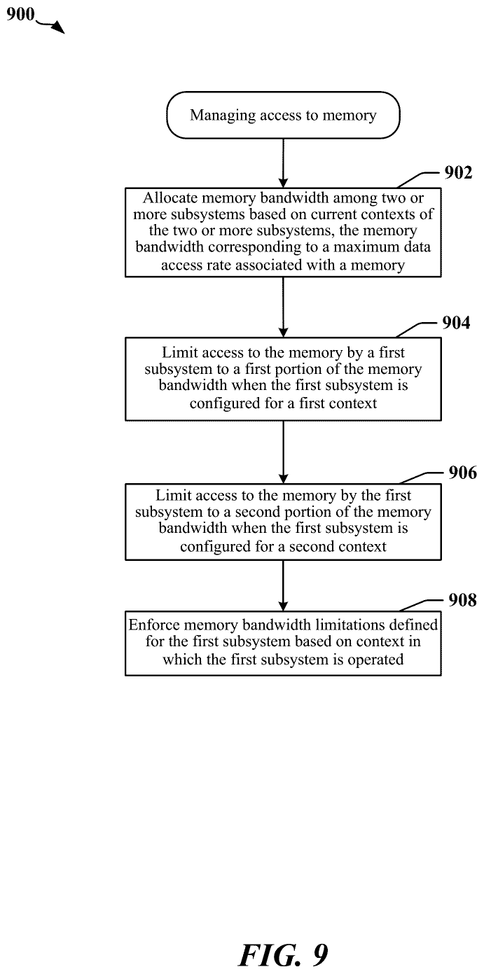

FIG. 9 is a flowchart 900 of a method for managing memory access in accordance with certain aspects of this disclosure. In some instances, the method is implemented using a processor, a controller, a finite state machine or some combination of processors, controllers and finite state machines. In one implementation, the method relates to one or more of the subsystems 704₁-704₇ illustrated in FIG. 7.

At block 902 in the illustrated method, memory bandwidth is allocated among two or more subsystems based on current contexts of the two or more subsystems. The memory bandwidth may correspond to a maximum data access rate associated with a memory. At block 904 in the illustrated method, access to the memory by a first subsystem may be limited to a first portion of the memory bandwidth when the first subsystem is configured for a first context. At block 906 in the illustrated method, access to the memory by the first subsystem may be limited to a second portion of the memory bandwidth when the first subsystem is configured for a second context. At block 908 in the illustrated method, memory bandwidth limitations are enforced. The memory bandwidth limitations may be defined for the first subsystem based on context in which the first subsystem is operated. In certain examples, the first context corresponds to a first use case and the second context corresponds to a second use case. The first use case may be associated with a safety requirement. The first portion of the memory bandwidth may be unlimited when the first use case is associated with a safety requirement.

In certain examples, a hypervisor may be configured to provide virtualized contexts in which virtual machines are operated. The first context may be a first virtualized context and the second context may be a second virtualized context when virtual machines are operated. A first bandwidth monitor may be configured to limit access to the memory by the first subsystem when the first subsystem is configured for the first context. A second bandwidth monitor may be configured to limit access to the memory by the first subsystem when the first subsystem is configured for the second context. The first virtualized context may be associated with a safety requirement. The first portion of the memory bandwidth may be unlimited when the first virtualized context is associated with a safety requirement.

In some implementations, the bandwidth monitoring subsystem is configured to redefine the memory bandwidth limitations when changes in memory bandwidth usage are indicated by measurements of the data access rate associated with the memory.

The method illustrated in FIG. 9 may be executed in or using an IC device in a chip set. The IC device may be an SoC. The IC device may include multiple semiconductor dice mounted on a substrate. In certain applications, at least one semiconductor die may be stacked on at least one other semiconductor die within an IC package. Each semiconductor die includes at least one circuit block configured to implement a function of the IC device. The IC device may include a controller and a first plurality of link modules configured to provide data transmit lanes and data receive lanes in a multimodule data communication link. The chip set may be embodied in a multiprocessing apparatus. The multiprocessing apparatus may include or be coupled to memory. The memory may be configured to support a maximum data access rate expressed as memory bandwidth. The multiprocessing apparatus may include a plurality of subsystems coupled to the memory, a bandwidth monitoring subsystem and a resource management subsystem. Each of the subsystems may be configured to switch between two or more contexts. The bandwidth monitoring subsystem may be configured to limit access to the memory by a first subsystem to a first portion of the memory bandwidth when the first subsystem is configured for a first context. The bandwidth monitoring subsystem may be further configured to limit access to the memory by the first subsystem to a second portion of the memory bandwidth when the first subsystem is configured for a second context. The resource management subsystem may be configured to enforce memory bandwidth limitations defined by the bandwidth monitoring subsystem based on context in which the first subsystem is operated.

In some implementations, the first context corresponds to a first use case and the second context corresponds to a second use case. The first use case may be associated with a safety requirement. The first portion of the memory bandwidth may be unlimited when the first use case is associated with a safety requirement.

In some implementations, a hypervisor is configured to provide virtualized contexts in which virtual machines are operated. The first context may be a first virtualized context and the second context may be a second virtualized context. The bandwidth monitoring subsystem may include a first bandwidth monitor that is configured to limit access to the memory by the first subsystem when the first subsystem is configured for the first context. The bandwidth monitoring subsystem may further include a second bandwidth monitor that is configured to limit access to the memory by the first subsystem when the first subsystem is configured for the second context. The first virtualized context may be associated with a safety requirement. The first portion of the memory bandwidth may be unlimited when the first virtualized context is associated with the safety requirement.

In some implementations, the memory bandwidth limitations correspond to an allocation of the memory bandwidth among the plurality of subsystems. The bandwidth monitoring subsystem may be configured to redefine the memory bandwidth limitations when changes are detected in memory bandwidth usage. The changes that are detected in memory bandwidth usage may be indicated by measurements of the data access rate associated with the memory.

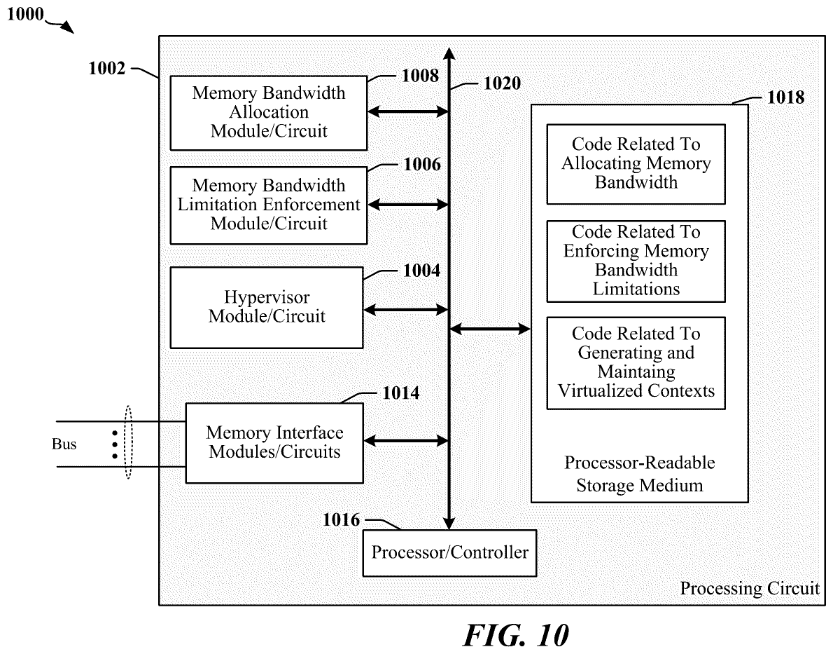

FIG. 10 is a diagram illustrating an example of a hardware implementation for an apparatus 1000 employing a processing circuit 1002. The processing circuit may include subsystems that have one or more microprocessors, microcontrollers, digital signal processors, sequencers and/or finite state machines, represented generally by the processor/controller 1016. The processing circuit 1002 may be implemented with a bus architecture, represented generally by the bus 1020. The bus 1020 may include any number of interconnecting buses and bridges depending on the specific application of the processing circuit 1002 and the overall design constraints. The bus 1020 links together various circuits including one or more processor/controller 1016, the modules or circuits 1004, 1006 and 1008 and the processor-readable storage medium 1018. A bus interface circuit and/or module 1014 may be provided to support access to a memory subsystem. The bus 1020 may also interconnect various other circuits such as timing sources, peripherals, voltage regulators, and power management circuits, which are well known in the art, and therefore, will not be described any further.

The processor/controller 1016 may be responsible for general processing, including the execution of software, code and/or instructions stored on the processor-readable storage medium 1018. The processor-readable storage medium 1018 may include a non-transitory storage medium. The software, when executed by the processor/controller 1016, causes the processing circuit 1002 to perform the various functions described supra for any particular apparatus. The processor-readable storage medium may be used for storing data that is manipulated by the processor/controller 1016 when executing software. The processing circuit 1002 further includes at least one of the modules 1004, 1006 and 1008. The modules 1004, 1006 and 1008 may be software modules running in the processor/controller 1016, resident/stored in the processor-readable storage medium 1018, one or more hardware modules coupled to the processor/controller 1016, or some combination thereof. The modules 1004, 1006 and 1008 may include microcontroller instructions, state machine configuration parameters, or some combination thereof.

In one configuration, the apparatus 1000 includes modules and/or circuits 1004 that are configured to provide virtualized contexts. The modules and/or circuits 1004 may include a hypervisor configured to support a plurality of virtual machines. The apparatus 1000 includes modules and/or circuits 1006 for enforcing memory bandwidth limitations on a plurality of subsystems. The apparatus 1000 may include modules and/or circuits 1008 for allocating memory bandwidth limitations on a plurality of subsystems.

In one example, each of the plurality of subsystems is operable in two or more contexts, each context being associated with a memory bandwidth allocation. A first subsystem may be operated in a first context that corresponds to a first use case and in a second context that corresponds to a second use case. The hypervisor may be configured to support a plurality of virtual machines.

The modules and/or circuits 1006 for enforcing memory bandwidth limitations on a plurality of subsystems may include a first bandwidth monitor configured to limit access to the memory by a first subsystem when the first subsystem is configured for operation in a first virtualized context, and a second bandwidth monitor configured to limit access to the memory by the first subsystem when the first subsystem is configured for operation in a second virtualized context. The first virtualized context may be associated with a safety requirement. Access to the memory by the first subsystem may be unlimited when the first virtualized context is associated with the safety requirement.

In some examples, the apparatus 1000 includes means for measuring data access rates associated with the memory. The memory bandwidth limitations may be redefined when the means for measuring data access rates indicates changes in memory bandwidth usage. In various aspects of the disclosure, the processor-readable storage medium 1018 stores code that, when executed by a processor, causes the processing circuit 1002 to allocate memory bandwidth among two or more subsystems based on current contexts of the two or more subsystems. The memory bandwidth may correspond to a maximum data access rate associated with a memory. The code may further cause the processing circuit 1002 to limit access to the memory by a first subsystem to a first portion of the memory bandwidth when the first subsystem is configured for a first context, limit access to the memory by the first subsystem to a second portion of the memory bandwidth when the first subsystem is configured for a second context, and enforce memory bandwidth limitations defined for the first subsystem based on context in which the first subsystem is operated.

In certain examples, the first context corresponds to a first use case and the second context corresponds to a second use case. The first use case may be associated with a safety requirement. The first portion of the memory bandwidth may be unlimited when the first use case is associated with the safety requirement.

In certain examples, a hypervisor may be configured to provide virtualized contexts in which virtual machines are operated. The first context may be a first virtualized context and the second context may be a second virtualized context. A first bandwidth monitor may be configured to limit access to the memory by the first subsystem when the first subsystem is configured for the first context. A second bandwidth monitor may be configured to limit access to the memory by the first subsystem when the first subsystem is configured for the second context. The first virtualized context may be associated with a safety requirement and the first portion of the memory bandwidth may be unlimited when the first virtualized context is associated with the safety requirement.

In certain examples, the bandwidth monitoring subsystem is configured to redefine the memory bandwidth limitations when changes in memory bandwidth usage are indicated by measurements of the data access rate associated with the memory.

Some implementation examples are described in the following numbered clauses:
1. A multiprocessing apparatus comprising: memory configured to support a maximum data access rate expressed as memory bandwidth; a plurality of subsystems coupled to the memory, each of the plurality of subsystems being configured to switch between two or more contexts; a bandwidth monitoring subsystem configured to limit access to the memory by a first subsystem to a first portion of the memory bandwidth when the first subsystem is configured for a first context, and to limit access to the memory by the first subsystem to a second portion of the memory bandwidth when the first subsystem is configured for a second context; and a resource management subsystem configured to enforce memory bandwidth limitations defined by the bandwidth monitoring subsystem based on context in which the first subsystem is operated.
2. The multiprocessing apparatus as described in clause 1, wherein the first context corresponds to a first use case and the second context corresponds to a second use case.
3. The multiprocessing apparatus as described in clause 1 or clause 2, wherein the first use case is associated with a safety requirement and wherein the first portion of the memory bandwidth is unlimited.
4. The multiprocessing apparatus as described in any of clauses 1-3, further comprising: a hypervisor configured to provide virtualized contexts in which virtual machines are operated, wherein the first context comprises a first virtualized context and the second context comprises a second virtualized context.
5. The multiprocessing apparatus as described in clause 4, wherein the bandwidth monitoring subsystem comprises a first bandwidth monitor configured to limit access to the memory by the first subsystem when the first subsystem is configured for the first context, and a second bandwidth monitor configured to limit access to the memory by the first subsystem when the first subsystem is configured for the second context.
6. The multiprocessing apparatus as described in clause 4 or clause 5, wherein the first virtualized context is associated with a safety requirement and wherein the first portion of the memory bandwidth is unlimited.
7. The multiprocessing apparatus as described in any of clauses 1-6, wherein the memory bandwidth limitations correspond to an allocation of the memory bandwidth among the plurality of subsystems, and wherein the bandwidth monitoring subsystem is configured to redefine the memory bandwidth limitations when changes are detected in memory bandwidth usage.
8. The multiprocessing apparatus as described in clause 7, wherein the changes that are detected in memory bandwidth usage are indicated by measurements of the data access rate associated with the memory.
9. A method for managing memory access comprising: allocating memory bandwidth among two or more subsystems based on current contexts of the two or more subsystems, the memory bandwidth corresponding to a maximum data access rate associated with a memory; limiting access to the memory by a first subsystem to a first portion of the memory bandwidth when the first subsystem is configured for a first context; limiting access to the memory by the first subsystem to a second portion of the memory bandwidth when the first subsystem is configured for a second context; and enforcing memory bandwidth limitations defined for the first subsystem based on context in which the first subsystem is operated.
10. The method as described in clause 9, wherein the first context corresponds to a first use case and the second context corresponds to a second use case.
11. The method as described in clause 9 or clause 10, wherein the first use case is associated with a safety requirement and wherein the first portion of the memory bandwidth is unlimited.
12. The method as described in any of clauses 9-11, further comprising: configuring a hypervisor to provide virtualized contexts in which virtual machines are operated, wherein the first context comprises a first virtualized context and the second context comprises a second virtualized context.
13. The method as described in clause 12, wherein a first bandwidth monitor is configured to limit access to the memory by the first subsystem when the first subsystem is configured for the first context, and wherein a second bandwidth monitor is configured to limit access to the memory by the first subsystem when the first subsystem is configured for the second context.
14. The method as described in clause 12 or clause 13, wherein the first virtualized context is associated with a safety requirement and wherein the first portion of the memory bandwidth is unlimited.
15. The method as described in any of clauses 9-14, wherein the bandwidth monitoring subsystem is configured to redefine the memory bandwidth limitations when changes in memory bandwidth usage are indicated by measurements of the data access rate associated with the memory.
16. An apparatus comprising: means for enforcing memory bandwidth limitations on a plurality of subsystems, each of the plurality of subsystems being operable in two or more contexts, each context being associated with a memory bandwidth allocation; and means for providing virtualized contexts in which one or more of the plurality of subsystems are operated.
17. The apparatus as described in clause 16, wherein a first subsystem operates in a first context that corresponds to a first use case and in a second context that corresponds to a second use case.
18. The apparatus as described in clause 16 or clause 17, wherein the means for providing the virtualized contexts comprises a hypervisor configured to support a plurality of virtual machines, and wherein the means for enforcing the memory bandwidth limitations on the plurality of subsystems comprises: a first bandwidth monitor configured to limit access to the memory by a first subsystem when the first subsystem is configured for operation in a first virtualized context; and a second bandwidth monitor configured to limit access to the memory by the first subsystem when the first subsystem is configured for operation in a second virtualized context.
19. The apparatus as described in clause 18, wherein the first virtualized context is associated with a safety requirement and wherein access to the memory by the first subsystem is unlimited.
20. The apparatus as described in any of clauses 16-19, further comprising: means for measuring data access rates associated with the memory, wherein the memory bandwidth limitations are redefined when the means for measuring data access rates indicates changes in memory bandwidth usage.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A multiprocessing apparatus comprising:
memory configured to support a maximum data access rate expressed as memory bandwidth;
a plurality of subsystems coupled to the memory, each of the plurality of subsystems being configured to switch between two or more contexts;
a bandwidth monitoring subsystem configured to limit access to the memory by a first subsystem to a first portion of the memory bandwidth when the first subsystem is configured for a first context, and to limit access to the memory by the first subsystem to a second portion of the memory bandwidth when the first subsystem is configured for a second context; and
a resource management subsystem configured to enforce memory bandwidth limitations defined by the bandwidth monitoring subsystem based on context in which the first subsystem is operated.

2. The multiprocessing apparatus of claim 1, wherein the first context corresponds to a first use case and the second context corresponds to a second use case.

3. The multiprocessing apparatus of claim 2, wherein the first use case is associated with a safety requirement and wherein the first portion of the memory bandwidth is unlimited.

4. The multiprocessing apparatus of claim 1, further comprising:
a hypervisor configured to provide virtualized contexts in which virtual machines are operated, wherein the first context comprises a first virtualized context and the second context comprises a second virtualized context.

5. The multiprocessing apparatus of claim 4, wherein the bandwidth monitoring subsystem comprises a first bandwidth monitor configured to limit access to the memory by the first subsystem when the first subsystem is configured for the first context, and a second bandwidth monitor configured to limit access to the memory by the first subsystem when the first subsystem is configured for the second context.

6. The multiprocessing apparatus of claim 4, wherein the first virtualized context is associated with a safety requirement and wherein the first portion of the memory bandwidth is unlimited.

7. The multiprocessing apparatus of claim 1, wherein the memory bandwidth limitations correspond to an allocation of the memory bandwidth among the plurality of subsystems, and wherein the bandwidth monitoring subsystem is configured to redefine the memory bandwidth limitations when changes are detected in memory bandwidth usage.

8. The multiprocessing apparatus of claim 7, wherein the changes that are detected in memory bandwidth usage are indicated by measurements of the data access rate associated with the memory.

9. A method for managing memory access comprising:
allocating memory bandwidth among two or more subsystems based on current contexts of the two or more subsystems, the memory bandwidth corresponding to a maximum data access rate associated with a memory;
limiting access to the memory by a first subsystem to a first portion of the memory bandwidth when the first subsystem is configured for a first context;
limiting access to the memory by the first subsystem to a second portion of the memory bandwidth when the first subsystem is configured for a second context; and
enforcing memory bandwidth limitations defined for the first subsystem based on context in which the first subsystem is operated.

10. The method of claim 9, wherein the first context corresponds to a first use case and the second context corresponds to a second use case.

11. The method of claim 10, wherein the first use case is associated with a safety requirement and wherein the first portion of the memory bandwidth is unlimited.

12. The method of claim 9, further comprising:
configuring a hypervisor to provide virtualized contexts in which virtual machines are operated, wherein the first context comprises a first virtualized context and the second context comprises a second virtualized context.

13. The method of claim 12, wherein a first bandwidth monitor is configured to limit access to the memory by the first subsystem when the first subsystem is configured for the first context, and wherein a second bandwidth monitor is configured to limit access to the memory by the first subsystem when the first subsystem is configured for the second context.

14. The method of claim 12, wherein the first virtualized context is associated with a safety requirement and wherein the first portion of the memory bandwidth is unlimited.

15. The method of claim 9, further comprising:
redefining the memory bandwidth limitations when changes in memory bandwidth usage are indicated by measurements of the data access rate associated with the memory.

16. An apparatus comprising:
means for enforcing memory bandwidth limitations on a plurality of subsystems, each of the plurality of subsystems being operable in two or more contexts, each context being associated with a memory bandwidth allocation; and
means for providing virtualized contexts in which one or more of the plurality of subsystems are operated.

17. The apparatus of claim 16, wherein a first subsystem operates in a first context that corresponds to a first use case and in a second context that corresponds to a second use case.

18. The apparatus of claim 16, wherein the means for providing the virtualized contexts comprises a hypervisor configured to support a plurality of virtual machines, and wherein the means for enforcing the memory bandwidth limitations on the plurality of subsystems comprises:
a first bandwidth monitor configured to limit access to the memory by a first subsystem when the first subsystem is configured for operation in a first virtualized context; and
a second bandwidth monitor configured to limit access to the memory by the first subsystem when the first subsystem is configured for operation in a second virtualized context.

19. The apparatus of claim 18, wherein the first virtualized context is associated with a safety requirement and wherein access to the memory by the first subsystem is unlimited.

20. The apparatus of claim 16, further comprising:
means for measuring data access rates associated with the memory, wherein the memory bandwidth limitations are redefined when the means for measuring data access rates indicates changes in memory bandwidth usage.
